(19) United States
(12) Patent Application Publication
(10) Pub. No.: US 2023/0176376 A1
(43) Pub. Date: Jun. 8, 2023

(54) LIGHTGUIDES WITH COLOR- AND TIME-SEQUENTIAL GRATINGS

(71) Applicant: Meta Platforms Technologies, LLC, Menlo Park, CA (US)

(72) Inventors: Babak Amirsolaimani, Redmond, WA (US); Renate Eva Klementine Landig, Seattle, WA (US); Andrew Maimone, Duvall, WA (US); Giuseppe Calafiore, Redmond, WA (US)

(21) Appl. No.: 17/581,303

(22) Filed: Jan. 21, 2022

Related U.S. Application Data
(60) Provisional application No. 63/286,349, filed on Dec. 6, 2021.
(60) Provisional application No. 63/286,230, filed on Dec. 6, 2021.

(51) Int. Cl. G02B 27/01; F21V 8/00

(52) U.S. Cl. CPC G02B 27/0172; G02B 6/0016; G02B 6/0038; G02B 2027/0174; G02B 2027/0112

(57) ABSTRACT

A lightguide for conveying image light to an eyebox of a display device includes a tunable grating, e.g. an out-coupling grating for out-coupling the image light from the lightguide. The tunable grating may be tuned or switched to effectively diffract light of a color channel of a color-sequential display. In augmented reality display systems, a lightguide combiner element may include a switchable grating to out-couple the image light only during short time intervals and to not out-couple the image light in between these time intervals. Effectively, the out-coupling grating is present only a portion of overall operation time of the display, which improves the transparency of the combiner element to the outside light and reduces rainbow effects.

### REFERENCE TO RELATED APPLICATION

This application claims priority from U.S. Provisional Patent Application No. 63/286,349 entitled “Active Gratings in Pupil-Replicated Displays and Illuminators”, and U.S. Provisional Patent Application No. 63/286,230, both filed on Dec. 6, 2021 and incorporated herein by reference in their entireties.

### TECHNICAL FIELD

The present disclosure relates to tunable optical devices, and in particular to lightguides usable in visual display systems, as well as and components, modules, and methods for lightguides and visual display systems.

### BACKGROUND

Visual displays provide information to viewer(s) including still images, video, data, etc. Visual displays have applications in diverse fields including entertainment, education, engineering, science, professional training, advertising, to name just a few examples. Some visual displays such as TV sets display images to several users, and some visual display systems such s near-eye displays (NEDs) are intended for individual users.

An artificial reality system generally includes an NED (e.g., a headset or a pair of glasses) configured to present content to a user. The near-eye display may display virtual objects or combine images of real objects with virtual objects, as in virtual reality (VR), augmented reality (AR), or mixed reality (MR) applications. For example, in an AR system, a user may view images of virtual objects (e.g., computer-generated images (CGIs)) superimposed with the surrounding environment by seeing through a “combiner” component. The combiner component including its light routing optics may be transparent to external light.

An NED is usually worn on the head of a user. Consequently, a large, bulky, unbalanced, and/or heavy display device with a heavy battery would be cumbersome and uncomfortable for the user to wear. Head-mounted display devices can benefit from a compact and efficient configuration, including efficient light sources and illuminators providing illumination of a display panel, high-throughput combiner components and ocular lenses, and other optical elements in the image forming train that can provide an image to a user's eye with minimal image distortions and artifacts.

### BRIEF DESCRIPTION OF THE DRAWINGS

Exemplary embodiments will now be described in conjunction with the drawings, in which:

FIG. 1 is a side cross-sectional view of a lightguide of this disclosure;

FIG. 2 is a schematic view of the lightguide of FIG. 1 including tunable grating(s) configured to diffract image light of red, green, and blue color channels in a time-sequential manner;

FIG. 3 is a schematic view of a display device using the lightguide of FIG. 1;

FIG. 4 is a flow chart of a method of this disclosure for conveying an image to an eyebox;

FIG. 5 is a schematic view of a display device using a pupil-replicating lightguide with a switchable out-coupling grating;

FIG. 6 is a sequence diagram illustrating the operation of the display device of FIG. 5;

FIG. 7 is a flow chart of a method of this disclosure for augmenting a view of outside environment with an artificially generated image;

FIG. 8 shows side cross-sectional views of a tunable liquid crystal (LC) surface-relief grating of this disclosure;

FIG. 9A is a frontal view of an active Pancharatnam-Berry phase (PBP) liquid crystal (LC) grating usable in a lightguide of this disclosure;

FIG. 9B is a magnified schematic view of LC molecules in an LC layer of the active PBP LC grating of FIG. 9A;

FIGS. 10A and 10B are side schematic views of the active PBP LC grating of FIGS. 9A and 9B, showing light propagation in OFF (FIG. 10A) and ON (FIG. 10B) states of the active PBP LC grating;

FIG. 11A is a side cross-sectional view of a polarization volumetric grating (PVH) usable in a lightguide of this disclosure;

FIG. 11B is a diagram illustrating optical performance of the PVH of FIG. 11A;

FIG. 12A is a side cross-sectional view of a fluidic grating usable in a lightguide of this disclosure, in an OFF state;

FIG. 12B is a side cross-sectional view of the fluidic grating of FIG. 12A in an ON state;

FIG. 13A is a side cross-sectional view of a lightguide of this disclosure including an acoustic actuator for creating a volume acoustic wave in the lightguide;

FIG. 13B is a side cross-sectional view of a lightguide of this disclosure including an acoustic actuator for creating a surface acoustic wave in the lightguide;

FIG. 14 is a view of an augmented reality (AR) display of this disclosure having a form factor of a pair of eyeglasses; and

FIG. 15 is a three-dimensional view of a head-mounted display (HMD) of this disclosure.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

As used herein, the terms “first”, “second”, and so forth are not intended to imply sequential ordering, but rather are intended to distinguish one element from another, unless explicitly stated. Similarly, sequential ordering of method steps does not imply a sequential order of their execution, unless explicitly stated.

Near-eye displays use lightguides to carry images to viewer's eyes and/or to illuminate display panels that generate images to be displayed. A lightguide may include grating structures for in-coupling a light beam into the lightguide, and for out-coupling portions of the light beam along the waveguide surface. In accordance with this disclosure, a grating structure of a lightguide may include a tunable/switchable grating with variable efficiency, period, blazing angle, etc. The terms “switchable”, “tunable”, and “variable” are used interchangeably herein, and mean that a grating parameter such as at least one of a grating strength, blazing angle, grating pitch, etc., may be controlled by applying an external control signal. The particular parameter being controlled depends on the type of tunable grating being used.

The tunability of grating parameters enables optimization of lightguide performance parameters such as optical throughput, eyebox size, artifacts suppression, etc. For example, for a color-sequential near-eye display, optical throughput may be optimized individually for light of each of red, green, and blue color channel. Furthermore, for an AR display, the combiner element transparency may be further improved by switching the out-coupling grating ON for brief moments of time to display the AR imagery, enabling a better view of the surrounding environment through the AR glasses while suppressing undesired image artifacts, rainbow effects, etc.

In accordance with the present disclosure, there is provided a lightguide for conveying light comprising at least one color channel of a plurality of color channels. The lightguide comprises a slab of transparent material for guiding the light therein by a series of internal reflections from opposed surfaces of the slab. An in-coupling grating structure is supported by the slab for in-coupling the light into the slab. An out-coupling grating structure is supported by the slab for out-coupling portions of the light from the slab. At least one of the in-coupling or out-coupling grating structures is tunable in at least one of a grating pitch or grating efficiency for operation with light of a particular one of the plurality of color channels of the light. The at least one of the in-coupling or out-coupling grating structures may include e.g. a polarization volume hologram (PVH) grating, a tunable Pancharatnam-Berry phase (PBP) liquid crystal (LC) grating, a tunable liquid crystal (LC) surface-relief grating, a fluidic grating, a switchable volumetric Bragg grating (VBG) per each one of the plurality of color channels, etc.

The lightguide may include e.g. a pupil-replicating lightguide. The plurality of color channels may include e.g. a red color channel, a green color channel, and a blue color channel. The out-coupling grating structure may have a spatially variant tunable grating pitch to out-couple the portions of the light from the lightguide at a pre-defined distribution of angles, and/or a spatially variant tunable grating efficiency to improve spatial uniformity of the portions of the light out-coupled from the slab by the out-coupling grating structure.

In accordance with the present disclosure, there is provided a display device for conveying an image comprising first and second color channels to an eyebox. The display device comprises a light engine for providing light comprising at least one of first and second light beams carrying the first and second color channels of the image respectively. A lightguide is coupled to the light engine for receiving the first and second light beams. A controller is operably coupled to the light engine.

The lightguide comprises: a slab of transparent material for guiding the light therein by a series of internal reflections from opposed surfaces of the slab; an in-coupling grating structure supported by the slab for in-coupling the light into the slab; and an out-coupling grating structure supported by the slab for out-coupling portions of the light from the slab. At least one of the in-coupling or out-coupling grating structures is tunable in at least one of grating pitch or grating efficiency for operation with light of a particular one of the first or second color channels. The in-coupling and/or out-coupling grating and may include any of the grating structures mentioned above, i.e. a polarization volume hologram (PVH) grating, a tunable Pancharatnam-Berry phase (PBP) liquid crystal (LC) grating, a tunable liquid crystal (LC) surface-relief grating, a fluidic grating, a switchable volumetric Bragg grating (VBG) per each one of the plurality of color channels, etc.

The controller may be configured to do the following: cause the light engine to provide the first light beam carrying the first color channel; tune the at least one of the in-coupling or out-coupling grating structures in at least one of a grating pitch or grating efficiency to increase throughput of the first light beam; cause the light engine to provide the second light beam carrying the second color channel; and tune the at least one of the in-coupling or out-coupling grating structures in at least one of a grating pitch or grating efficiency to increase throughput of the second light beam. The light engine may be further configured to provide a third light beam carrying a third color channel of the image to be displayed. The controller may be further configured to cause the light engine to provide the third light beam and tune the at least one of the in-coupling or out-coupling grating structures in at least one of a grating pitch or grating efficiency to increase throughput of the third light beam. The controller may tune the respective gratings in a time-sequential manner.

In embodiments where the lightguide is a pupil-replicating lightguide, the out-coupling grating structure may have at least one of a spatially variant tunable grating pitch or a spatially variant tunable grating efficiency to out-couple the portions of the first and second light beams from the slab at a pre-defined distribution of angles and/or with a pre-defined spatial uniformity.

In accordance with the present disclosure, there is further provided a method for conveying an image to an eyebox. The method comprises providing a first light beam carrying a first color channel of the image. The first light beam is coupled to an in-coupling grating structure of a lightguide comprising an out-coupling grating structure for out-coupling portions of the first light beam. At least one of the in-coupling or out-coupling grating structures is tuned in at least one of a grating pitch or grating efficiency to increase throughput of the first light beam. A second light beam is provided, carrying a second color channel of the image. The second light beam is coupled to the in-coupling grating of the lightguide. The at least one of the in-coupling or out-coupling grating structures is tuned in at least one of the grating pitch or the grating efficiency to increase throughput of the second light beam. A third light beam carrying a third color channel of the image may be provided. The at least one of the in-coupling or out-coupling grating structures may be tuned in at least one of the grating pitch or the grating efficiency to increase throughput of the second light beam.

In some embodiments, the out-coupling grating structure has a spatially variant tunable grating pitch to out-couple the portions of the first and second light beams from the lightguide at a pre-defined distribution of angles. The out-coupling grating structure may have a spatially variant tunable grating efficiency to out-couple the portions of the first and second light beams from the lightguide with a pre-defined spatial uniformity.

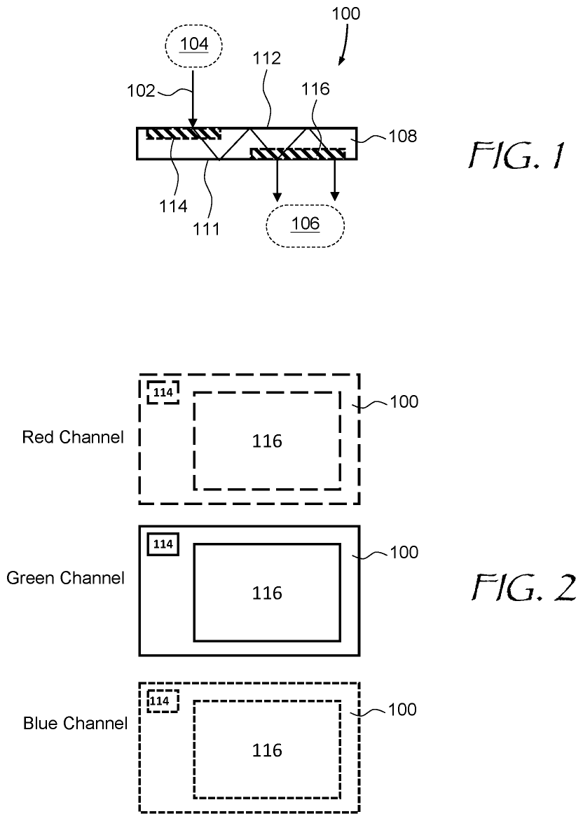

Referring now to FIG. 1, a lightguide 100 conveys light 102 from an input location 104 to an output location 106. The lightguide 100 includes a slab 108 of transparent material for guiding the light 102 in the slab 108 by a series of internal reflections from opposed surfaces 111, 112 of the slab 108. The light 102 may be reflected from the opposed surfaces 111, 112 by total internal reflection (TIR). The lightguide 102 further includes an in-coupling grating structure 114 supported by the slab 108 for in-coupling the light 102 into the slab 108, and an out-coupling grating structure 116 supported by the slab 108 for out-coupling portions of the light from the slab 108. The in-coupling grating structure 114 and the out-coupling grating structure 116 may be disposed in the slab 108, as shown, or on the slab 108. The out-coupling grating structure 116 may, but does not have to, provide multiple laterally offset portions of the light 102 at the output location 106, in which case the lightguide 100 is termed a pupil-replicating lightguide.

In some embodiments, the light 102 may be used for illumination of a display panel or another optical element at the output location 106. In some embodiments, the light 102 may carry an image in angular domain to be viewed at the output location 106. The light 102 includes a plurality of color channels for example red, green, and blue color channels. The light of individual color channels may be provided in a time-sequential manner. For example, at a first time interval, the light 102 may carry a red color channel, i.e. a beam of red light; at a subsequent second time interval, the light 102 may carry a green color channel, i.e. a beam of green light; and at a subsequent third time interval, the light 102 may carry a blue color channel, i.e. a beam of blue light. The first, second, and third time intervals may repeat in a time-sequential manner while the display is in operation, to provide an RGB image.

In embodiments where the light 102 simultaneously carries several color channels, the in-coupling grating structure 114 and the out-coupling grating structure 116 need to be configured to operate with light all color channels simultaneously, i.e. the grating structures 114 and 116 need to be optimized for operation with a multi-color light. Such optimization often requires a compromise where the diffraction efficiency of the grating structures 114 and 116 at particular wavelengths of individual color channels is reduced to diffract light of all wavelengths or color channels with approximately similar efficiency. This, however, is no longer required when the light of individual color channels is provided in a time-sequential manner as explained above. At least one of the in-coupling 114 or out-coupling 116 grating structures may tunable in at least one of a grating pitch or grating efficiency for operation with light of a particular one of the plurality of color channels of the light 102. The tunability of the in-coupling 114 and/or out-coupling 116 grating structures enables one to optimize the grating performance for each color channel individually, thereby raising overall diffraction efficiency and improving throughput of the lightguide 100.

In embodiments where the lightguide 100 is a pupil-replicating lightguide and the light 102 carries a plurality of color channels e.g. a red color channel, a green color channel, and a blue color channel, the out-coupling grating structure 116 may have a spatially variant grating pitch independently tunable for each of the color channels to a pre-configured spatial pitch distribution to out-couple the portions of the light from the lightguide at a pre-defined distribution of angles. This enables the spatial pitch distribution to be optimized separately for each color channel. In this an other pupil-replicating lightguide embodiments, the out-coupling grating structure 116 may have a spatially variant grating efficiency. The spatially variant grating efficiency is independently tunable for each of the color channels to improve spatial uniformity of the portions of the light out-coupled from the slab by the out-coupling grating structure 116.

Referring to FIG. 2, the color-selective performance of the lightguide 100 is schematically illustrated for three consecutive time intervals, i.e. the first, second, and third intervals discussed above. During the first time interval, the light 102 includes a light beam of the red color channel, and the in-coupling grating structure 114 and/or the out-coupling grating structure 116 are tuned to improve or maximize the optical throughput of the red color channel light (long-dashed lines at the top of FIG. 2). During the second time interval, the light 102 includes a light beam of the green color channel, and the in-coupling grating structure 114 and/or the out-coupling grating structure 116 are tuned to improve or maximize the optical throughput of the green color channel light (solid lines at the middle of FIG. 2). Finally, during the third time interval, the light 102 includes a light beam of the blue color channel, and the in-coupling grating structure 114 and/or the out-coupling grating structure 116 are tuned to improve or maximize the optical throughput for the blue color channel light (short-dash lines at the bottom of FIG. 2). Of course, the displaying order of the red, green, and blue color channels may be changed if needed.

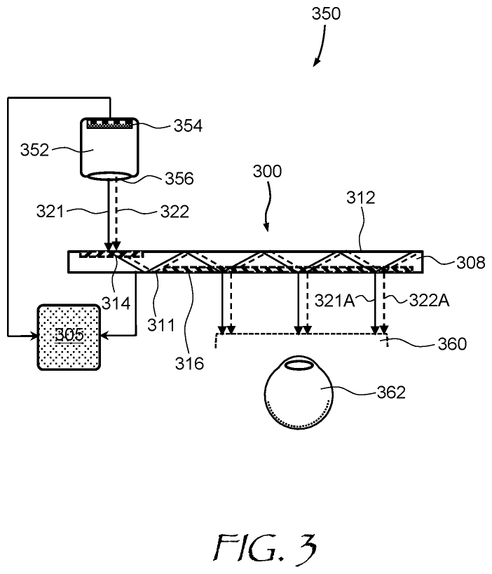

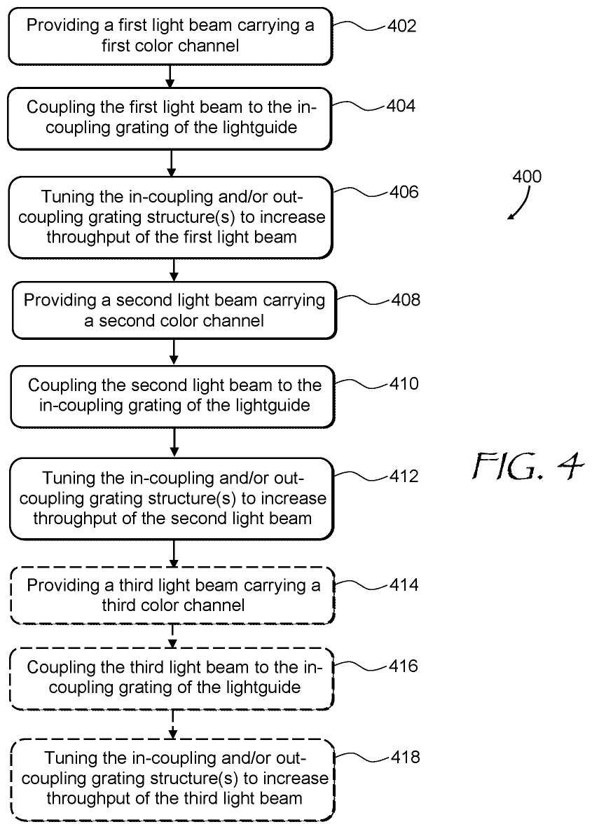

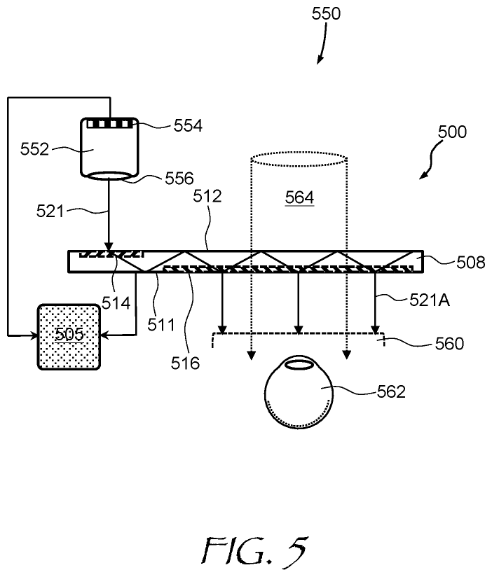

Turning to FIG. 3, a display device 350 includes a light engine 352 coupled to a pupil-replicating lightguide 300, and a controller 305 operably coupled to the light engine 352 and the pupil-replicating lightguide 300. The light engine 352 provides image light carrying an image in angular domain to be viewed by a user's eye 362 at an eyebox 360. To that end, the light engine 352 may emit first 321 and second 322 light beams carrying first and second color channels, respectively, of the image light. There may be more than two color channels, e.g. three or even more color channels, and accordingly three or more light beams, each light beam carrying its own color channel. In the illustrated embodiment, the light engine 352 includes a display panel 354 coupled to a projector lens 356 for converting an image in linear domain displayed by the display panel 354 into the image in angular domain. In some embodiments, the light engine 352 may include a beam scanner for rastering the image in angular domain.

The pupil-replicating lightguide 300 is based on the lightguide 100 of FIG. 1, and includes similar elements. Any suitable embodiment of the lightguide 100 may be used. Briefly, the pupil-replicating lightguide 300 of FIG. 3 includes a slab 308 of transparent material e.g. glass, metal oxide, crystal, plastic, etc. The slab 308 that guides the first light beam 321 (solid lines) and the second light beam 322 (dashed lines) in the slab 308 by a series of internal reflections from first 311 and second 312 opposed surfaces of the slab 308. The first 321 and second 322 light beams are shown offset from one another for convenience of illustration.

The first 311 and second 312 surfaces run parallel to each other and may be straight, as shown, or curved in some embodiments. The pupil-replicating lightguide 300 includes an in-coupling grating structure 314 supported by the slab 308 for in-coupling the first 321 and second 322 light beams into the slab 308. The pupil-replicating lightguide 300 further includes an out-coupling grating structure 316 supported by the slab 308 for out-coupling portions 321A, 322A of the first 321 and second 322 light beams, respectively, from the slab 308. At least one of in-coupling 314 or out-coupling 316 grating structures of the pupil-replicating lightguide 300 is tunable in at least one of a grating pitch or grating efficiency for operation with light of a particular one of the first or second color channels.

The controller 305 may be suitably configured, for example programmed with software, firmware, and/or hard-wired, to cause the light engine 352 to provide the first light beam 321 carrying the first color channel. The controller 305 tunes the at least one of the in-coupling 314 or out-coupling 316 grating structures in at least one of a grating pitch or grating efficiency to increase throughput of the first light beam 321 from the light engine 352 to the eyebox 360. In other words, the grating pitch and/or grating efficiency are selected such that the light of the first color channel, e.g. red light, is conveyed to the eyebox 360 with high efficiency. Then, the controller 305 causes the light engine 352 to provide the second light beam 322 carrying the second color channel. The controller 305 tunes the at least one of the in-coupling 314 or out-coupling 316 grating structures in at least one of a grating pitch or grating efficiency to increase throughput of the second light beam. In other words, the grating pitch and/or grating efficiency are selected by the controller 305 such that the light of the second color channel, e.g. green light, is conveyed to the eyebox 360 with a higher efficiency.

The controller 305 may cause the light engine 352 to provide a third light beam, not shown in FIG. 3 for brevity, carrying a third color channel. The controller 305 then tunes the at in-coupling 314 and/or out-coupling 316 grating structures in at least one of a grating pitch or grating efficiency to increase throughput of the third light beam, e.g. a blue light beam.

The light beams of individual color channels may be provided in a time-sequential fashion, during consecutive time intervals. At each of these time intervals, the in-coupling 314 and/or out-coupling grating 316 parameter(s) are tuned for optimal transmission of a particular one of the color channels. A display with a sequential presentation of color channels is termed herein a color-sequential display. In some embodiments of a color-sequential display, the out-coupling grating structure 316 may have at least one of a spatially variant tunable grating pitch or a spatially variant tunable grating efficiency to out-couple the portions 321A, 322 of the first 321 and second 322 light beams from the slab 308 at a pre-defined distribution of angles and with a pre-defined spatial uniformity, as required by a specific construction and viewing requirements of the display device 350.

Referring now to FIG. 4 with further reference to FIG. 3, a method 400 for conveying an image to an eyebox of a display device includes providing (402) a first light beam carrying a first color channel, e.g. a red color channel, of the image. The first light beam is coupled (404) to an in-coupling grating structure of a lightguide, e.g. the in-coupling grating 314 of the lightguide 300 of FIG. 3. The at least one of the in-coupling 314 or out-coupling 316 grating structures is tuned (FIG. 4; 406) a grating pitch and/or grating efficiency to increase throughput of the first light beam, e.g. to optimize the grating structures 314, 316 for conveying the light of red color channel of the image to be displayed.

A second light beam is then provided (408). The second light beam carries a second color channel of the image, e.g. a green color channel. The second light beam is coupled (410) to the in-coupling grating of the lightguide. The in-coupling and/or out-coupling grating structure is tuned (412) in the grating pitch and/or grating efficiency to increase throughput of the second light beam, e.g. to optimize the grating structures 314, 316 to convey the light of green color channel of the image to be displayed.

A third light beam may be then provided (414). The third light beam carries a third color channel of the image, e.g. a blue color channel. The third light beam is coupled (416) to the in-coupling grating of the lightguide. The in-coupling and/or out-coupling grating structure is tuned (418) in the grating pitch and/or grating efficiency to increase throughput of the third light beam, e.g. to optimize the grating structures 314, 316 to convey the light of blue color channel of the image to be displayed. As explained above, the out-coupling grating structure 316 may have a spatially variant tunable grating pitch to out-couple the portions of the first and second light beams from the slab 308 at a pre-defined distribution of angles. The out-coupling grating structure 316 may also have a spatially variant tunable grating efficiency to out-couple the portions of the first and second light beams from the slab 308 with a pre-defined spatial uniformity.

The steps 402, 404, 406 related to the first color channel may be performed within a first time interval. The steps 408, 410, 412 related to the second color channel may be performed within a second time interval following the first time interval. The steps 414, 416, 418 related to the third color channel may be performed within a third time interval following the second time interval. Then, the steps 402 to 418 method 400 may be repeated. Thus, the different color channels of the image may be displayed in a time-sequential manner, with the in-coupling 314 and/or out-coupling 316 grating structures being optimized each time for displaying a particular color channel.

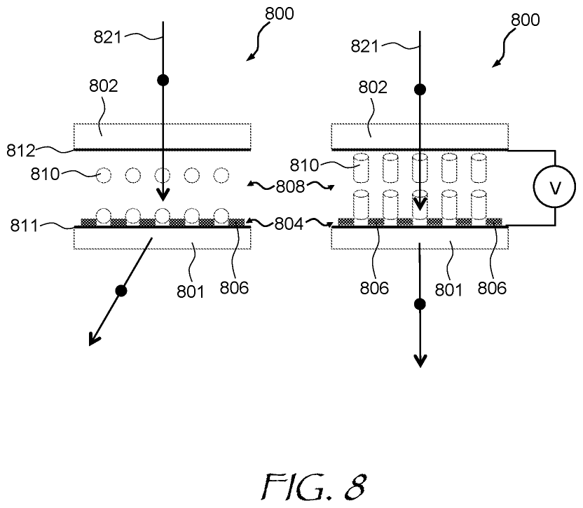

Example implementations of the in-coupling 314 and/or out-coupling 316 grating structures will be considered further below with reference to FIGS. 8-13. Each one of the in-coupling 314 and/or out-coupling 316 grating structures may include individual tunable gratings per grating structure or multiple gratings per grating structure, one grating per color channel. The grating may be switched on and off depending on whether the particular channel is being displayed at any given moment of time.

Turning now to FIG. 5, a near-eye display 550 includes a light engine 552 for providing image light 521 carrying an image in angular domain, a pupil-replicating lightguide 500 coupled to the light engine 552 for expanding the image light 521, and a controller 505 operably coupled to the light engine 552 and the pupil-replicating lightguide 500. In the illustrated embodiment, the light engine 552 includes a display panel 554 coupled to a projector lens 556 for converting an image in linear domain displayed by the display panel 554 into the image in angular domain. In some embodiments, the light engine 552 may include a beam scanner for rastering the image in angular domain.

The pupil-replicating lightguide 500 includes a slab 508 of transparent material, e.g. glass, metal oxide, crystal, plastic, etc., for guiding the image light 521 in the slab 508 by a series of internal reflections from opposed surfaces 511, 512 of the slab 508 while transmitting outside visible light 564 through the slab 508. The opposed surfaces 511, 512 may be outer surfaces of the slab 508 or alternatively, in some embodiments, extra layers may be provided. The pupil-replicating lightguide 500 may further include an in-coupling grating 514 supported by the slab 508 for in-coupling the image light 521 into the slab 508. An out-coupling grating 516 may be supported by the slab 508 for out-coupling portions 521A of the image light 521 from the slab 508 to propagate towards an eyebox 560, enabling a user's eye 562 to see the image. The portions 521A are laterally offset from one another along a path of the image light 521 in the slab 508, as illustrated. The out-coupling grating 516 has a diffraction efficiency switchable between a high-efficiency state, in which a percentage P₁ of image light out-coupled from the slab 508 is above a first threshold L₁, and a low-efficiency state, in which a percentage P₂ of image light out-coupled from the slab 508 is below a second threshold L₂ lower than the first threshold L₁. The high-efficiency state may correspond to a maximum diffraction efficiency of the out-coupling grating 516, and the low-efficiency state may correspond to a state when the out-coupling grating 516 diffracts little light, or no light at all.

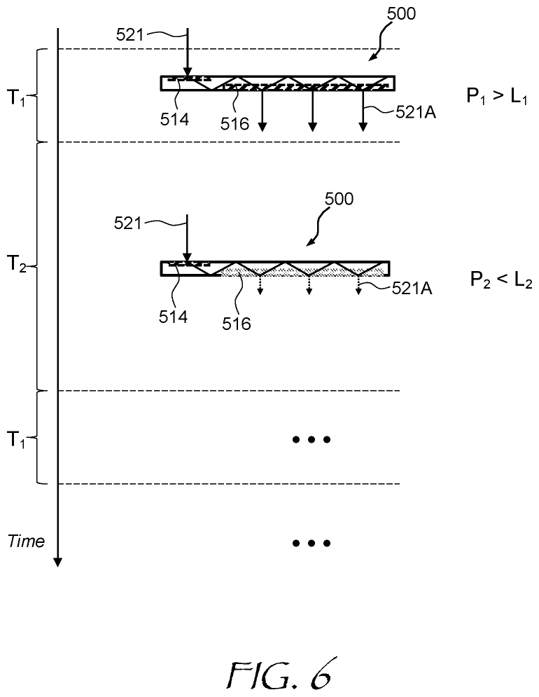

Referring to FIG. 6 with further reference to FIG. 5, the controller 505 (FIG. 5) may be suitably configured, for example programmed with software, firmware, and/or hard-wired, to cause the light engine 552 to provide the image light 521 during a first time interval T₁ (FIG. 6), and to switch the out-coupling grating 516 to the high-efficiency state during the first time interval T₁. During a subsequent second time interval T₂, the controller 505 switches the out-coupling grating to the low-efficiency state. The second time interval T₂ may immediately follow the first time interval T₁. The next first time interval T₁ may immediately follow the second time interval T₂, and so on. The pupil-replicating lightguide 500 may be configured to transmit the outside visible light 564 therethrough during the first T₁ and second T₂ time intervals, or only during the first time interval T₁. To save power, the controller 505 may be configured to cause the light engine 552 to provide no image light during the second time interval T₂, i.e. to switch off the light engine 552 during the second time interval T₂.

One benefit of only switching the out-coupling grating 516 to the high-efficiency state during the first time interval T₁ is a better transmission of the outside visible light 564 through the pupil-replicating lightguide 500. When the out-coupling grating 516 is in the low-efficiency state, the throughput of the outside visible light 564 is improved, and possible artifacts such as rainbow artifacts, for example, are reduced. The second threshold L₂ may be at least three times lower than the first threshold L₁, or at least ten times lower or even hundred times lower than the first threshold L₁. To further improve the outside visible light 564 throughput of the pupil-replicating lightguide 500, the second time interval T₂ may be at least two times, or in some embodiments nine times larger than the first time interval T₁, or even at least one hundred times larger than the first time interval T₁.

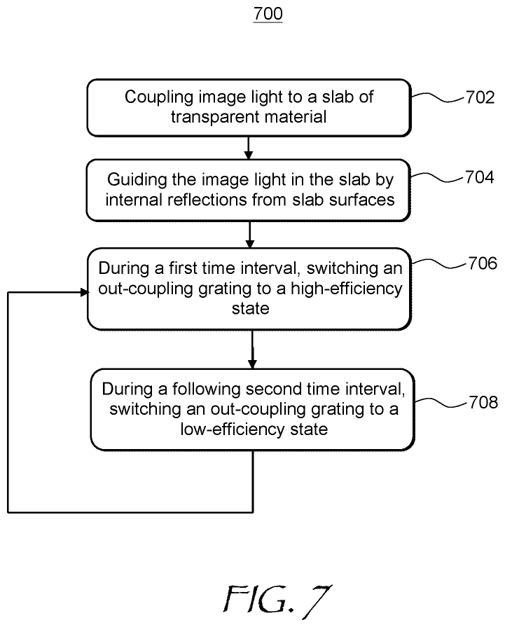

Turning to FIG. 7 with further reference to FIGS. 5 and 6, a method 700 for augmenting a view of outside environment with a generated image, e.g. a real view augmenting image or a virtual image, includes coupling (702) image light carrying the generated image, e.g. the image light 521 generated by the light engine 552 (FIG. 5), to a slab of transparent material e.g. the slab 508. The outside environment is observable through the slab 508 by allowing the outside visible light 564 propagate through the slab 508 and the out-coupling grating 516 of the pupil-replicating lightguide 500.

The image light 521 is guided (FIG. 7; 704) in the slab 508 by a series of internal reflections from opposed surfaces 511, 512 of the slab 508. During the first time interval T₁, the out-coupling grating 516 is switched (706) to the high-efficiency state and remains in the high-efficiency state, in which the out-coupling grating 516 out-couples the laterally offset portions 521A of the image light 521 from the slab. As described above, a percentage of the image light 521 out-coupled from the slab 508 as the portions 521A is above the first threshold L₁. During the second time interval T₂ following the first time interval T₁, the out-coupling grating 516 is switched (708) to the low-efficiency state, in which the percentage of image light 521 out-coupled from the slab 508 is below the second threshold L₂ lower than the first threshold L₁. The second threshold L₂ may be at least ten times lower than the first threshold L₁. The second time interval T₂ may be at least nine times larger than the first time interval T₁.

The two last steps 706 and 708 may then repeat in a cyclic fashion, one after another. The out-coupling grating 516 may be switched again to the high efficiency state during a third time interval (i.e. the repeated first interval) following the second time interval. Then, out-coupling grating 516 may be switched again to the low efficiency state during a fourth time interval (i.e. the repeated second time interval) following the third time interval, and so on. The image light 521 may be coupled to the slab 508 only during the intervals when the out-coupling grating 516 is switched to the high-efficiency state, to preserve power. The out-coupling grating 516 may have less rainbow effects in the low-efficiency state than in the high-efficiency state. Switching the out-coupling grating 516 to the low-efficiency state for a considerable fraction of the viewing time results in a reduction of overall rainbow effects and other image and/or viewing artifacts, and may also improve overall transparency of the pupil-replicating lightguide 500 to the outside visible light 564.

Non-limiting examples of switchable/tunable gratings usable in lightguides and displays of this disclosure will now be presented. Referring first to FIG. 8, a tunable liquid crystal (LC) surface-relief grating 800 may be used e.g. in the in-coupling grating structure 114 and/or the out-coupling grating structure 116 of FIGS. 1 and 2, the in-coupling grating structure 314 and/or the out-coupling grating structure 316 of FIG. 3, the in-coupling grating structure 514 and/or the out-coupling grating structure 516 of FIGS. 5 and 6. The tunable LC surface-relief grating 800 includes a first substrate 801 supporting a first conductive layer 811 and a surface-relief grating structure 804 having a plurality of ridges 806 extending from the first substrate 801 and/or the first conductive layer 811.

A second substrate 802 is spaced apart from the first substrate 801. The second substrate 802 supports a second conductive layer 812. A cell is formed by the first 811 and second 812 conductive layers. The cell is filled with a LC fluid, forming an LC layer 808. The LC layer 808 includes nematic LC molecules 810, which may be oriented by an electric field across the LC layer 808. The electric field may be provided by applying a voltage V to the first 811 and second 812 conductive layers.

The surface-relief grating structure 804 may be formed from a polymer with an isotropic refractive index nₚ of about 1.5, for example. The LC fluid has an anisotropic refractive index. For light polarization parallel to a director of the LC fluid, i.e. to the direction of orientation of the nematic LC molecules 810, the LC fluid has an extraordinary refractive index nₑ, which may be higher than an ordinary refractive index nₒ of the LC fluid for light polarization perpendicular to the director. For example, the extraordinary refractive index nₑ may be about 1.7, and the ordinary refractive index nₒ may be about 1.5, i.e. matched to the refractive index nₚ of the surface-relief grating structure 804.

When the voltage Vis not applied (left side of FIG. 8), the LC molecules 810 are aligned approximately parallel to the grooves of the surface-relief grating structure 804. At this configuration, a linearly polarized light beam 821 with e-vector oriented along the grooves of the surface-relief grating structure 804 will undergo diffraction, since the surface-relief grating structure 804 will have a non-zero refractive index contrast. When the voltage V is applied (right side of FIG. 8), the LC molecules 810 are aligned approximately perpendicular to the grooves of the surface-relief grating structure 804. At this configuration, a linearly polarized light beam 821 with e-vector oriented along the grooves of the surface-relief grating structure 804 will not undergo diffraction because the surface-relief grating structure 804 will appear to be index-matched and, accordingly, will have a substantially zero refractive index contrast. For the linearly polarized light beam 821 with e-vector oriented perpendicular to the grooves of the surface-relief grating structure 804, no diffraction will occur in either case (i.e. when the voltage is applied and when it is not) because at this polarization of the linearly polarized light beam 821, the surface-relief grating structure 804 are index-matched. Thus, the tunable LC surface-relief grating 800 can be switched on and off (for polarized light) by controlling the voltage across the LC layer 808. Several such gratings with differing pitch/slant angle/refractive index contrast may be used to switch between several grating configurations.

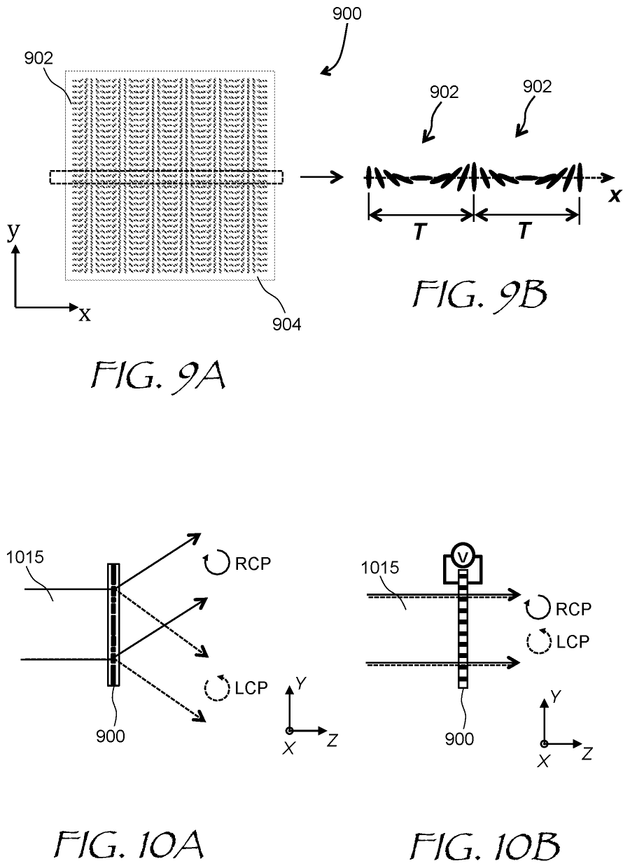

Referring now to FIG. 9A, a Pancharatnam-Berry phase (PBP) LC switchable grating 900 may be used e.g. in the in-coupling grating structure 114 and/or the out-coupling grating structure 116 of FIGS. 1 and 2, the in-coupling grating structure 314 and/or the out-coupling grating structure 316 of FIG. 3, the in-coupling grating structure 514, and/or the out-coupling grating structure 516 of FIGS. 5 and 6. The PBP LC switchable grating 900 of FIG. 9A includes LC molecules 902 in an LC layer 904. The LC molecules 902 are disposed in XY plane at a varying in-plane orientation depending on the X coordinate. The orientation angle ϕ(x) of the LC molecules 902 in the PBP LC switchable grating 900 is given by

ϕ(x)=πx/T=πx sin θ/λₒ (1)

where λₒ is the wavelength of impinging light, T is a pitch of the PBP LC switchable grating 900, and θ is a diffraction angle given by

θ=sin⁻¹(λₒ/T) (2)

The azimuthal angle ϕ varies continuously across the surface of an LC layer 904 parallel to XY plane as illustrated in FIG. 9B. The variation has a constant period equal to T. The optical phase delay P in the PBP LC grating 900 of FIG. 9A is due to the PBP effect, which manifests P(x)=2ϕ(x) when the optical retardation R of the LC layer 904 is equal to λ₁₁/2.

FIGS. 10A and 10B illustrate the operation of the PBP LC switchable grating 900 of FIG. 9A. The PBP LC switchable grating 900 includes the LC layer 904 (FIG. 9A) disposed between parallel substrates configured for applying an electric field across the LC layer 904. The LC molecules 902 are oriented substantially parallel to the substrates in absence of the electric field, and substantially perpendicular to the substrates in presence of the electric field.

In FIG. 10A, the PBP LC switchable grating 900 is in OFF state, such that its LC molecules 902 (FIGS. 9A, 9B) are disposed predominantly parallel to the substrate plane, that is, parallel to XY plane in FIG. 10A. When an incoming light beam 1015 is left-circular polarized (LCP), the PBP LC switchable grating 900 redirects the light beam 1015 upwards by a pre-determined non-zero angle, and the beam 1015 becomes right-circular polarized (RCP). The RCP deflected beam 1015 is shown with solid lines. When the incoming light beam 1015 is right-circular polarized (RCP), the PBP LC switchable grating 900 redirects the beam 1015 downwards by a pre-determined non-zero angle, and the beam 1015 becomes left-circular polarized (LCP). The LCP deflected beam 1015 is shown with dashed lines. Applying a voltage V to the PBP LC switchable grating 900 reorients the LC molecules along Z-axis, i.e. perpendicular to the substrate plane as shown in FIG. 10B. At this orientation of the LC molecules 902, the PBP structure is erased, and the light beam 1015 retains its original direction, whether it is LCP or RCP. Thus, the active PBP LC grating 900 is a tunable grating, i.e. it has a variable beam steering property. Furthermore, the operation of the active PBP LC grating 900 may be controlled by controlling the polarization state of the impinging light beam 1015.

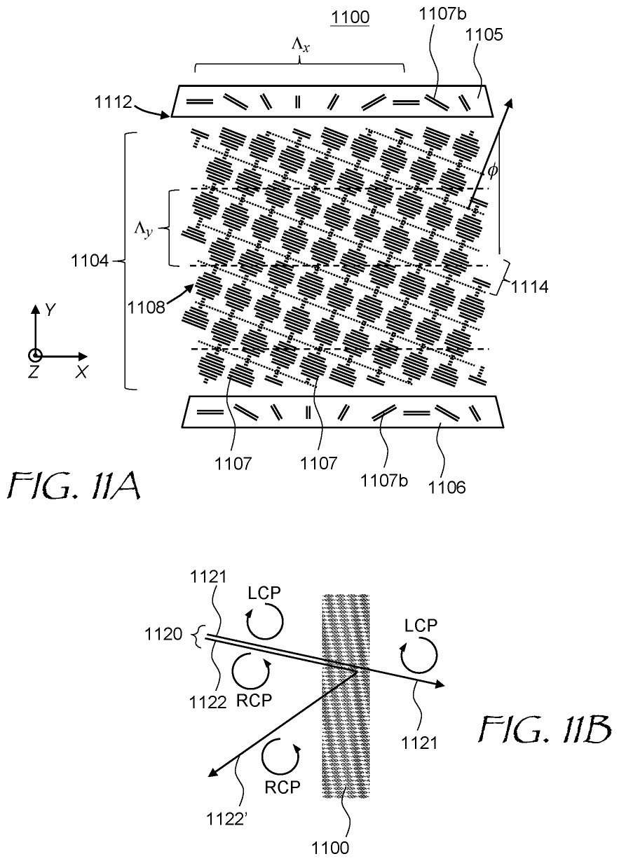

Turning to FIG. 11A, a polarization volume hologram (PVH) grating 1100 may be used e.g. in the in-coupling grating structure 114 and/or the out-coupling grating structure 116 of FIGS. 1 and 2, the in-coupling grating structure 314 and/or the out-coupling grating structure 316 of FIG. 3, or in the in-coupling grating structure 514 and/or the out-coupling grating structure 516 of FIGS. 5 and 6. The PVH grating 1100 of FIG. 11A includes an LC layer 1104 bound by opposed top 1105 and bottom 1106 parallel surfaces. The LC layer 1104 may include an LC fluid containing rod-like LC molecules 1107 with positive dielectric anisotropy, i.e. nematic LC molecules. A chiral dopant may be added to the LC fluid, causing the LC molecules in the LC fluid to self-organize into a periodic helical configuration including helical structures 1108 extending between the top 1105 and bottom 1106 parallel surfaces of the LC layer 1104. Such a configuration of the LC molecules 1107, termed herein a cholesteric configuration, includes a plurality of helical periods p, e.g. at least two, at least five, at least ten, at least twenty, or at least fifty helical periods p between the top 1105 and bottom 1106 parallel surfaces of the LC layer 1104.

Boundary LC molecules 1107b at the top surface 1105 of the LC layer 1104 may be oriented at an angle to the top surface 1105. The boundary LC molecules 1107b may have a spatially varying azimuthal angle, e.g. linearly varying along X-axis parallel to the top surface 1105, as shown in FIG. 11A. To that end, an alignment layer 1112 may be provided at the top surface 1105 of the LC layer 1104. The alignment layer 1112 may be configured to provide the desired orientation pattern of the boundary LC molecules 1107b, such as the linear dependence of the azimuthal angle on the X-coordinate. A pattern of spatially varying polarization directions of the UV light may be selected to match a desired orientation pattern of the boundary LC molecules 1107b at the top surface 1105 and/or the bottom surface 1106 of the LC layer 1104. When the alignment layer 1112 is coated with the cholesteric LC fluid, the boundary LC molecules 1107b are oriented along the photopolymerized chains of the alignment layer 1112, thus adopting the desired surface orientation pattern. Adjacent LC molecules adopt helical patterns extending from the top 1105 to the bottom 1106 surfaces of the LC layer 1104, as shown.

The boundary LC molecules 1107b define relative phases of the helical structures 1108 having the helical period p. The helical structures 1108 form a volume grating comprising helical fringes 1114 tilted at an angle ϕ, as shown in FIG. 11A. The steepness of the tilt angle ϕ depends on the rate of variation of the azimuthal angle of the boundary LC molecules 1107b at the top surface 1105 and p. Thus, the tilt angle ϕ is determined by the surface alignment pattern of the boundary LC molecules 1107b at the alignment layer 1112. The volume grating has a period Λₓ along X-axis and Λ_{y} along Y-axis. In some embodiments, the periodic helical structures 1108 of the LC molecules 1107 may be polymer-stabilized by mixing in a stabilizing polymer into the LC fluid, and curing (polymerizing) the stabilizing polymer.

The helical nature of the fringes 1114 of the volume grating makes the PVH grating 1100 preferably responsive to light of polarization having one particular handedness, e.g. left- or right-circular polarization, while being substantially non-responsive to light of the opposite handedness of polarization. Thus, the helical fringes 1114 make the PVH grating 1100 polarization-selective, causing the PVH grating 1100 to diffract light of only one handedness of circular polarization. This is illustrated in FIG. 11B, which shows a light beam 1120 impinging onto the PVH grating 1100. The light beam 1120 includes a left circular polarized (LCP) beam component 1121 and a right circular polarized (RCP) beam component 1122. The LCP beam component 1121 propagates through the PVH grating 1100 substantially without diffraction. Herein, the term “substantially without diffraction” means that, even though an insignificant portion of the beam (the LCP beam component 1121 in this case) might diffract, the portion of the diffracted light energy is so small that it does not impact the intended performance of the PVH grating 1100. The RCP beam component 1122 of the light beam 1120 undergoes diffraction, producing a diffracted beam 1122′. The polarization selectivity of the PVH grating 1100 results from the effective refractive index of the grating being dependent on the relationship between the handedness, or chirality, of the impinging light beam and the handedness, or chirality, of the grating fringes 1114. Changing the handedness of the impinging light may be used to switch the performance of the PVH grating 1100. The PVH grating 1100 may also be made tunable by applying voltage to the LC layer 1104, which distorts or erases the above-described helical structure. It is further noted that sensitivity of the PVH 1100 to right circular polarized light in particular is only meant as an illustrative example. When the handedness of the helical fringes 1114 is reversed, the PVH 1100 may be made sensitive to left circular polarized light. Thus, the operation of the PVH 1100 may be controlled by controlling the polarization state of the impinging light beam 1120. Furthermore, in some embodiments the PVH 1100 may be made tunable by application of electric field across the LC layer 1104, which erases the periodic helical structures 1108.

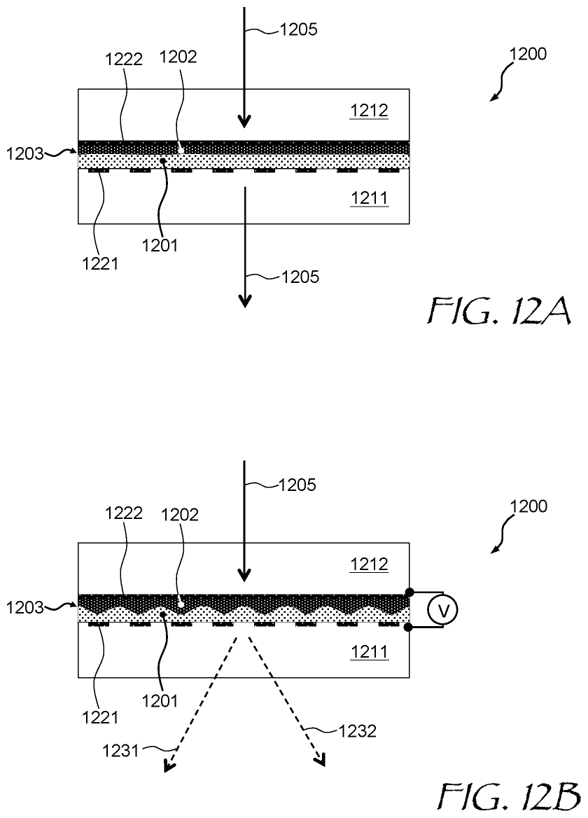

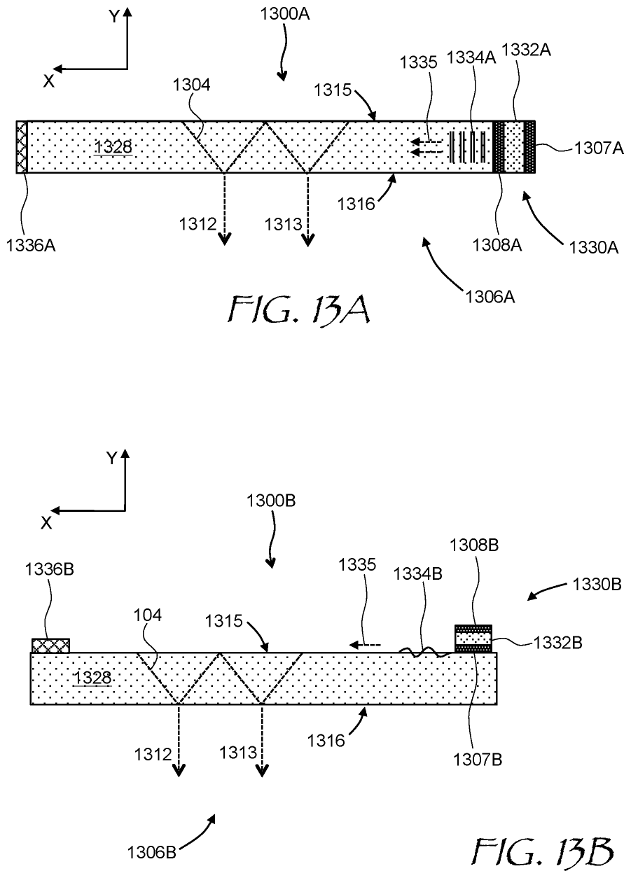

Referring now to FIGS. 12A and 12B, a fluidic surface-relief grating 1200 may be used e.g. in the in-coupling grating structure 114 and/or the out-coupling grating structure 116 of FIGS. 1 and 2, the in-coupling grating structure 314 and/or the out-coupling grating structure 316 of FIG. 3, and in the in-coupling grating structure 514 and/or the out-coupling grating structure 516 of FIGS. 5 and 6. The fluidic surface-relief grating 1200 includes first 1201 and second 1202 immiscible fluids separated by an inter-fluid boundary 1203. One of the fluids may be a hydrophobic fluid such as oil, e.g. silicone oil, while the other fluid may be water-based. One of the first 1201 and second 1202 fluids may be a gas in some embodiments. The first 1201 and second 1202 fluids may be contained in a cell formed by first 1211 and second 1212 substrates supporting first 1221 and second 1222 electrode structures. The first 1221 and/or second 1222 electrode structures may be at least partially transparent, absorptive, and/or reflective.

At least one of the first 1221 and second 1222 electrode structures may be patterned for imposing a spatially variant electric field onto the 1201 and second 1202 fluids. For example, in 12A and 12B, the first electrode 1221 is patterned, and the second electrodes 1222 is not patterned, i.e. the second electrodes 1222 is a backplane electrode. In the embodiment shown, both the first 1221 and second 1222 electrodes are substantially transparent. For example, the first 1221 and second 1222 electrodes may be indium tin oxide (ITO) electrodes. The individual portions of a patterned electrode may be individually addressable. In some embodiments, the patterned electrode 1221 may be replaced with a continuous, non-patterned electrode coupled to a patterned dielectric layer for creating a spatially non-uniform electric field across the first 1201 and second 1202 fluids.

FIG. 12A shows the fluidic surface-relief grating 1200 in a non-driven state when no electric field is applied across the inter-fluid boundary 1203. When no electric field is present, the inter-fluid boundary 1203 is straight and smooth; accordingly, a light beam 1205 impinging onto the fluidic surface-relief grating 1200 does not diffract, propagating right through as illustrated. FIG. 12B shows the fluidic surface-relief grating 1200 in a driven state when a voltage V is applied between the first 1221 and second 1222 electrodes, producing a spatially variant electric field across the first 1201 and second 1202 fluids separated by the inter-fluid boundary 1203. The application of the spatially variant electric field causes the inter-fluid boundary 1203 to distort as illustrated in FIG. 12B, forming a periodic variation of effective refractive index, i.e. a surface-relief diffraction grating. The light beam 1205 impinging onto the fluidic surface-relief grating 1200 will diffract, forming first 1231 and second 1232 diffracted sub-beams. By varying the amplitude of the applied voltage V, the strength of the fluidic surface-relief grating 1200 may be varied. By applying different patterns of the electric field e.g. with individually addressable sub-electrodes or pixels of the first electrode 1221, the grating period and, accordingly, the diffraction angle, may be varied. More generally, varying the effective voltage between separate sub-electrodes or pixels of the first electrode 1221 may result in a three-dimensional conformal change of the fluidic interface i.e. the inter-fluid boundary 1203 inside the fluidic volume to impart a desired optical response to the fluidic surface-relief grating 1200. The applied voltage pattern may be pre-biased to compensate or offset gravity effects, i.e. gravity-caused distortions of the inter-fluid boundary 1203.

The thickness of the first 1221 and second 1222 electrodes may be e.g. between 10 nm and 50 nm. The materials of the first 1221 and second 1222 electrodes besides ITO may be e.g. indium zinc oxide (IZO), zinc oxide (ZO), indium oxide (IO), tin oxide (TO), indium gallium zinc oxide (IGZO), etc. The first 1201 and second 1202 fluids may have a refractive index difference of at least 0.1, and may be as high as 0.2 and higher. One of the first 1201 or second 1202 fluids may include polyphenylether, 1,3-bis(phenylthio)benzene, etc. The first 1211 and/or second 1212 substrates may include e.g. fused silica, quartz, sapphire, etc. The first 1211 and/or second 1212 substrates may be straight or curved, and may include vias and other electrical interconnects. The applied voltage may be varied in amplitude and/or duty cycle when applied at a frequency of between 100 Hz and 100 kHz. The applied voltage can change polarity and/or be bipolar. Individual first 1201 and/or second 1202 fluid layers may have a thickness of between 0.5-5 micrometers, more preferably between 0.5-2 micrometer.

To separate the first 1201 and second 1202 fluids, surfactants containing one hydrophilic end functional group and one hydrophobic end functional group may be used. The examples of a hydrophilic end functional group are hydroxyl, carboxyl, carbonyl, amino, phosphate, sulfhydryl. The hydrophilic functional groups may also be anionic groups such as sulfate, sulfonate, carboxylates, phosphates, for example. Non-limiting examples of a hydrophobic end functional group are aliphatic groups, aromatic groups, fluorinated groups. For example, when polyphenyl thioether and fluorinated fluid may be selected as a fluid pair, a surfactant containing aromatic end group and fluorinated end group may be used. When phenyl silicone oil and water are selected as the fluid pair, a surfactant containing aromatic end group and hydroxyl (or amino, or ionic) end group may be used. These are only non-limiting examples.

Referring to FIG. 13A, a pupil-replicating lightguide 1300A of this disclosure includes a body 1306A having two portions, a substrate 1328 for propagating image light 1304, and a volume-wave acoustic actuator 1330A mechanically coupled at a side of the substrate 1328 joining its top 1315 and bottom 1316 surfaces. In the embodiment shown, the volume-wave acoustic actuator 1330A includes an electrically responsive layer 1332A, e.g. a piezoelectric layer, disposed between electrodes 1307A, 1308A. In operation, an electrical signal at a high frequency, typically in the range of 1 MHz to 100 MHz or higher, is applied to the electrodes 1307A, 1308A causing the electrically responsive layer 1332A to oscillate, typically at a frequency of a mechanical resonance of the electrically responsive layer 1332A. The oscillating thickness of the electrically responsive layer 1332A creates a volume acoustic wave 1334A propagating in the substrate 1328 in a direction 1335, i.e. along the X-axis. The volume acoustic wave 1334A modulates the refractive index of the substrate 1328 due to the effect of photoelasticity. The modulated refractive index creates a diffraction grating that out-couples portions 1312, 1313 of the image light 1304 from the pupil-replicating lightguide 1300A. By changing the strength of the electric signal applied to the volume-wave acoustic actuator 1330A, the strength of the out-coupling grating may be changed. The out-coupling grating may be switched ON and OFF by switching ON and OFF the oscillating electric signal. The grating period may be changed by changing the frequency of the oscillating electric signal. In some embodiments, an acoustic wave terminator 1336A can be coupled to an opposite side of the substrate 1328 to absorb the volume acoustic wave 1334A and thus prevent a standing acoustic wave formation in the substrate 1328.

Turning to FIG. 13B, a pupil-replicating waveguide 1300B of the present disclosure includes a waveguide body 1306B having two portions, the substrate 1328 for propagating the beam of image light 1304, and a surface-wave acoustic actuator 1330B mechanically coupled at the top surface 1315. Alternatively, the surface-wave acoustic actuator 1330B may also be coupled at the bottom surface 1316. In the embodiment shown, the surface-wave acoustic actuator 1330B includes an electrically responsive layer 1332B, e.g. a piezoelectric layer, disposed between electrodes 1307B, 1308B. In operation, an electrical signal at a high frequency, typically in the range of 1 MHz to 100 MHz or higher, is applied to the electrodes 1307B, 1308B causing the electrically responsive layer 1332B to oscillate. The oscillation of the electrically responsive layer 1332A creates a surface acoustic wave 1334B propagating in the substrate 1328 in the direction 1335, i.e. along the X-axis. The surface acoustic wave 1334B forms a diffraction grating that out-couples the portions 1312, 1313 of the image light 1304 from the pupil-replicating lightguide 1300B. By changing the strength of the electric signal applied to the surface-wave acoustic actuator 1330B, the strength of the surface grating may be changed. The surface grating may be switched ON and OFF by switching ON and OFF the oscillating electric signal. The grating period may be changed by changing the frequency of the oscillating electric signal. In some embodiments, an acoustic wave terminator 1336B can be coupled to an opposite side of the substrate 1328 at the same surface, i.e. at the top surface 1315 in FIG. 13B, to absorb the surface acoustic wave 1334B and thus prevent a standing acoustic wave formation.

Some switchable gratings include a material with tunable refractive index. By way of a non-limiting example, a holographic polymer-dispersed liquid crystal (H-PDLC) grating may be manufactured by causing interference between two coherent laser beams in a photosensitive monomer/liquid crystal (LC) mixture contained between two substrates coated with a conductive layer. Upon irradiation, a photoinitiator contained within the mixture initiates a free-radical reaction, causing the monomer to polymerize. As the polymer network grows, the mixture phase separates into polymer-rich and liquid-crystal rich regions. The refractive index modulation between the two phases causes light passing through the cell to be scattered in the case of traditional PDLC or diffracted in the case of H-PDLC. When an electric field is applied across the cell, the index modulation is removed and light passing through the cell is unaffected. This is described in an article entitled “Electrically Switchable Bragg Gratings from Liquid Crystal/Polymer Composites” by Pogue et al., Applied Spectroscopy, v. 54 No. 1, 2000, which is incorporated herein by reference in its entirety.

Tunable or switchable gratings with a variable grating period may be produced e.g. by using flexoelectric LC. For LCs with a non-zero flexoelectric coefficient difference (e1−e3) and low dielectric anisotropy, electric fields exceeding certain threshold values result in transitions from the homogeneous planar state to a spatially periodic one. Field-induced grating is characterized by rotation of the LC director about the alignment axis with the wavevector of the grating oriented perpendicular to the initial alignment direction. The rotation sign is defined by both the electric field vector and the sign of the (e1−e3) difference. The wavenumber characterizing the field-induced periodicity is increased linearly with the applied voltage starting from a threshold value of about π/d, where d is the thickness of the layer. A description of flexoelectric LC gratings may be found e.g. in an article entitled “Dynamic and Photonic Properties of Field-Induced Gratings in Flexoelectric LC Layers” by Palto in Crystals 2021, 11, 894, which is incorporated herein by reference in its entirety.

Tunable gratings with a variable grating period or a slant angle may be provided e.g. by using helicoidal LC. Tunable gratings with helicoidal LCs have been described e.g. in an article entitled “Electrooptic Response of Chiral Nematic Liquid Crystals with Oblique Helicoidal Director” by Xiang et al. Phys. Rev. Lett. 112, 217801, 2014, which is incorporated herein by reference in its entirety.

For gratings exhibiting strong wavelength dependence of grating efficiency, several gratings, e.g. several volumetric Bragg grating (VBG) gratings, may be provided in the lightguide. The gratings that diffract light at any given moment of time may be switched by switching the VBG grating on and off, and/or by switching the wavelength of the light propagating in the waveguide.

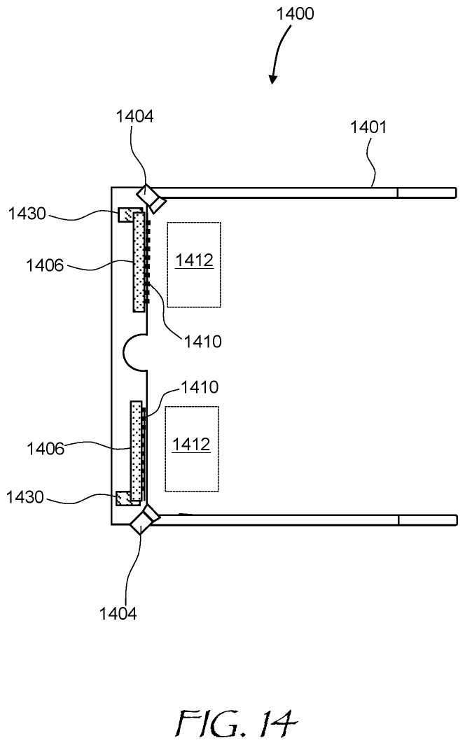

Referring now to FIG. 14, an augmented reality (AR) near-eye display 1400 includes a frame 1401 supporting, for each eye: a light engine 1430 for providing an image light beam carrying an image in angular domain, a pupil-replicating lightguide 1406 including any of the waveguides disclosed herein, for providing multiple offset portions of the image light beam to spread the image in angular domain across an eyebox 1412, and a plurality of eyebox illuminators 1410, shown as black dots, spread around a clear aperture of the pupil-replicating lightguide 1406 on a surface that faces the eyebox 1412. An eye-tracking camera 1404 may be provided for each eyebox 1412.

The purpose of the eye-tracking cameras 1404 is to determine position and/or orientation of both eyes of the user. The eyebox illuminators 1410 illuminate the eyes at the corresponding eyeboxes 1412, allowing the eye-tracking cameras 1404 to obtain the images of the eyes, as well as to provide reference reflections i.e. glints. The glints may function as reference points in the captured eye image, facilitating the eye gazing direction determination by determining position of the eye pupil images relative to the glints images. To avoid distracting the user with the light of the eyebox illuminators 1410, the latter may be made to emit light invisible to the user. For example, infrared light may be used to illuminate the eyeboxes 1412.

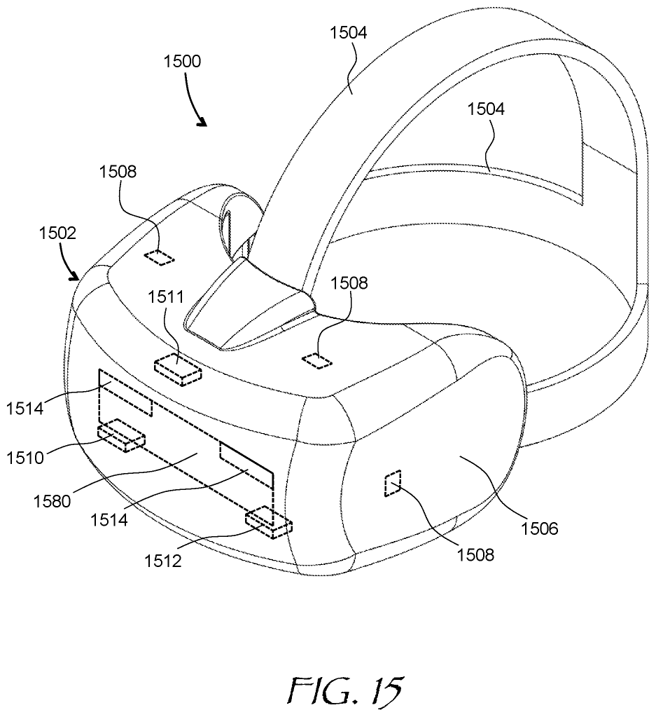

Turning to FIG. 15, an HMD 1500 is an example of an AR/VR wearable display system which encloses the user's face, for a greater degree of immersion into the AR/VR environment. The HMD 1500 may generate the entirely virtual 3D imagery. The HMD 1500 may include a front body 1502 and a band 1504 that can be secured around the user's head. The front body 1502 is configured for placement in front of eyes of a user in a reliable and comfortable manner. A display system 1580 may be disposed in the front body 1502 for presenting AR/VR imagery to the user. The display system 1580 may include any of the display devices and waveguides disclosed herein. Sides 1506 of the front body 1502 may be opaque or transparent.

In some embodiments, the front body 1502 includes locators 1508 and an inertial measurement unit (IMU) 1510 for tracking acceleration of the HMD 1500, and position sensors 1512 for tracking position of the HMD 1500. The IMU 1510 is an electronic device that generates data indicating a position of the HMD 1500 based on measurement signals received from one or more of position sensors 1512, which generate one or more measurement signals in response to motion of the HMD 1500. Examples of position sensors 1512 include: one or more accelerometers, one or more gyroscopes, one or more magnetometers, another suitable type of sensor that detects motion, a type of sensor used for error correction of the IMU 1510, or some combination thereof. The position sensors 1512 may be located external to the IMU 1510, internal to the IMU 1510, or some combination thereof.

The locators 1508 are traced by an external imaging device of a virtual reality system, such that the virtual reality system can track the location and orientation of the entire HMD 1500. Information generated by the IMU 1510 and the position sensors 1512 may be compared with the position and orientation obtained by tracking the locators 1508, for improved tracking accuracy of position and orientation of the HMD 1500. Accurate position and orientation is important for presenting appropriate virtual scenery to the user as the latter moves and turns in 3D space.

The HMD 1500 may further include a depth camera assembly (DCA) 1511, which captures data describing depth information of a local area surrounding some or all of the HMD 1500. The depth information may be compared with the information from the IMU 1510, for better accuracy of determination of position and orientation of the HMD 1500 in 3D space.

The HMD 1500 may further include an eye tracking system 1514 for determining orientation and position of user's eyes in real time. The obtained position and orientation of the eyes also allows the HMD 1500 to determine the gaze direction of the user and to adjust the image generated by the display system 1580 accordingly. The determined gaze direction and vergence angle may be used to adjust the display system 1580 to reduce the vergence-accommodation conflict. The direction and vergence may also be used for displays' exit pupil steering as disclosed herein. Furthermore, the determined vergence and gaze angles may be used for interaction with the user, highlighting objects, bringing objects to the foreground, creating additional objects or pointers, etc. An audio system may also be provided including e.g. a set of small speakers built into the front body 1502.

Embodiments of the present disclosure may include, or be implemented in conjunction with, an artificial reality system. An artificial reality system adjusts sensory information about outside world obtained through the senses such as visual information, audio, touch (somatosensation) information, acceleration, balance, etc., in some manner before presentation to a user. By way of non-limiting examples, artificial reality may include virtual reality (VR), augmented reality (AR), mixed reality (MR), hybrid reality, or some combination and/or derivatives thereof. Artificial reality content may include entirely generated content or generated content combined with captured (e.g., real-world) content. The artificial reality content may include video, audio, somatic or haptic feedback, or some combination thereof. Any of this content may be presented in a single channel or in multiple channels, such as in a stereo video that produces a three-dimensional effect to the viewer. Furthermore, in some embodiments, artificial reality may also be associated with applications, products, accessories, services, or some combination thereof, that are used to, for example, create content in artificial reality and/or are otherwise used in (e.g., perform activities in) artificial reality. The artificial reality system that provides the artificial reality content may be implemented on various platforms, including a wearable display such as an HMD connected to a host computer system, a standalone HMD, a near-eye display having a form factor of eyeglasses, a mobile device or computing system, or any other hardware platform capable of providing artificial reality content to one or more viewers.

The present disclosure is not to be limited in scope by the specific embodiments described herein. Indeed, other various embodiments and modifications, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A lightguide for conveying light comprising at least one of a plurality of color channels, the lightguide comprising:
a slab of transparent material for guiding the light therein by a series of internal reflections from opposed surfaces of the slab;
an in-coupling grating structure supported by the slab for in-coupling the light into the slab; and
an out-coupling grating structure supported by the slab for out-coupling portions of the light from the slab;
wherein at least one of the in-coupling or out-coupling grating structures is tunable in at least one of a grating pitch or grating efficiency for operation with light of a particular one of the plurality of color channels of the light.

2. The lightguide of claim 1, wherein the at least one of the in-coupling or out-coupling grating structures comprises a polarization volume hologram (PVH) grating.

3. The lightguide of claim 1, wherein the at least one of the in-coupling or out-coupling grating structures comprises a tunable Pancharatnam-Berry phase (PBP) liquid crystal (LC) grating.

4. The lightguide of claim 1, wherein the at least one of the in-coupling or out-coupling grating structures comprises a tunable liquid crystal (LC) surface-relief grating.

5. The lightguide of claim 1, wherein the at least one of the in-coupling or out-coupling grating structures comprises a fluidic surface-relief grating.

6. The lightguide of claim 1, wherein the at least one of the in-coupling or out-coupling grating structures comprises a switchable volumetric Bragg grating (VBG) per each one of the plurality of color channels.

7. The lightguide of claim 1, wherein:
the lightguide is a pupil-replicating lightguide; and
the plurality of color channels comprises a red color channel, a green color channel, and a blue color channel;
wherein the out-coupling grating structure has a spatially variant tunable grating pitch to out-couple the portions of the light from the lightguide at a pre-defined distribution of angles.

8. The lightguide of claim 1, wherein:
the lightguide is a pupil-replicating lightguide; and
the plurality of color channels comprises a red color channel, a green color channel, and a blue color channel;
wherein the out-coupling grating structure has a spatially variant tunable grating efficiency to improve spatial uniformity of the portions of the light out-coupled from the slab by the out-coupling grating structure.

9. A display device for conveying an image comprising first and second color channels to an eyebox, the display device comprising:
a light engine for providing light comprising at least one of first and second light beams carrying the first and second color channels respectively;
a lightguide coupled to the light engine for receiving the light, the lightguide comprising:
a slab of transparent material for guiding the light therein by a series of internal reflections from opposed surfaces of the slab;
an in-coupling grating structure supported by the slab for in-coupling the light into the slab; and
an out-coupling grating structure supported by the slab for out-coupling portions of the light from the slab;
wherein at least one of the in-coupling or out-coupling grating structures is tunable in at least one of grating pitch or grating efficiency for operation with light of a particular one of the first or second color channels; and
a controller operably coupled to the light engine and the lightguide and configured to:
cause the light engine to provide the first light beam carrying the first color channel;
tune the at least one of the in-coupling or out-coupling grating structures in at least one of a grating pitch or grating efficiency to increase throughput of the first light beam;
cause the light engine to provide the second light beam carrying the second color channel; and
tune the at least one of the in-coupling or out-coupling grating structures in at least one of a grating pitch or grating efficiency to increase throughput of the second light beam.

10. The display device of claim 9, wherein the at least one of the in-coupling or out-coupling grating structures comprises a polarization volume hologram (PVH) grating.

11. The display device of claim 9, wherein the at least one of the in-coupling or out-coupling grating structures comprises a tunable Pancharatnam-Berry phase (PBP) liquid crystal (LC) grating.

12. The display device of claim 9, wherein the at least one of the in-coupling or out-coupling grating structures comprises a tunable liquid crystal (LC) surface-relief grating.

13. The display device of claim 9, wherein the at least one of the in-coupling or out-coupling grating structures comprises a fluidic surface-relief grating.

14. The display device of claim 9, wherein the at least one of the in-coupling or out-coupling grating structures comprises a switchable volumetric Bragg grating (VBG) per each one of the first and second color channels.

15. The display device of claim 9, wherein the lightguide is a pupil-replicating lightguide, and wherein the out-coupling grating structure has at least one of a spatially variant tunable grating pitch or a spatially variant tunable grating efficiency to out-couple the portions of the first and second light beams from the slab at a pre-defined distribution of angles and with a pre-defined spatial uniformity.

16. The display device of claim 9, wherein:
the light further comprises a third color channel of the image;
the light engine is further configured for providing a third light beam carrying the third color channel; and
the controller is further programmed to:
cause the light engine to provide the third light beam; and
tune the at least one of the in-coupling or out-coupling grating structures in at least one of a grating pitch or grating efficiency to increase throughput of the third light beam.

17. A method for conveying an image to an eyebox, the method comprising:
providing a first light beam carrying a first color channel of the image;
coupling the first light beam to an in-coupling grating structure of a lightguide comprising an out-coupling grating structure for out-coupling portions of the first light beam;
tuning at least one of the in-coupling or out-coupling grating structures in at least one of a grating pitch or grating efficiency to increase throughput of the first light beam;
providing a second light beam carrying a second color channel of the image;
coupling the second light beam to the in-coupling grating of the lightguide; and
tuning the at least one of the in-coupling or out-coupling grating structures in at least one of the grating pitch or the grating efficiency to increase throughput of the second light beam.

18. The method of claim 17, further comprising:
providing a third light beam carrying a third color channel of the image;
coupling the third light beam to the in-coupling grating of the lightguide; and
tuning the at least one of the in-coupling or out-coupling grating structures in at least one of the grating pitch or the grating efficiency to increase throughput of the third light beam.

19. The method of claim 17, wherein the out-coupling grating structure has a spatially variant tunable grating pitch to out-couple the portions of the first and second light beams from the lightguide at a pre-defined distribution of angles.

20. The method of claim 17, wherein the out-coupling grating structure has a spatially variant tunable grating efficiency to out-couple the portions of the first and second light beams from the lightguide with a pre-defined spatial uniformity.
